(19) United States
(12) Patent Application Publication
(10) Pub. No.: US 2026/0243020 A1
(43) Pub. Date: Aug. 20, 2026

(54) DECORATION FEEDER OF DECORATION ATTACHMENT DEVICE

(71) Applicant: DSTECH CO.,LTD, Siheung-si, Gyeonggi-do (KR)

(72) Inventors: Sang Young KIM, Siheung-si, Gyeonggi-do (KR); Dong Wook LEE, Ansan-si, Gyeonggi-do (KR)

(73) Assignee: DSTECH CO.,LTD, Siheung-si, Gyeonggi-do (KR)

(21) Appl. No.: 19/162,047

(22) PCT Filed: Nov. 23, 2023
(86) PCT No.: PCT/KR2023/018959

§ 371 Date: Sep. 3, 2025

(30) Foreign Application Priority Data
Mar. 15, 2023 (KR) 10-2023-0033924

(51) Int. Cl. D06Q 1/10; B44C 1/18

(52) U.S. Cl. CPC D06Q 1/10; B44C 1/18

(57) ABSTRACT

The present invention relates to a decoration feeder of a decoration attachment device provided in an apparatus for automatically attaching various types of decorations used to decorate products such as clothing and bags, wherein, in particular, decorations inserted into an insertion hole of a rotating plate are supplied to a settling hole of a rotating drum located below and then discharged one by one as a push pin repeatedly moves up and down, thus having the effect that the decorations can be easily attached to desired points in desired shapes and the size of the product can be reduced.

### TECHNICAL FIELD

The present invention relates to a decoration attachment device, and more particularly, to a decoration feeder of a decoration attachment device that can accurately supply decorations while having a simplified structure and reduced volume.

### BACKGROUND ART

Typically, products such as clothing, bags, and belts are decorated with decorations such as spangles, beads, hot-fixes, and nails made of materials such as hot melt plastic, metal, glass, and artificial diamonds.

Among such decorations, spangles, beads or the like are melted and attached by applying ultrasonic waves with an ultrasonic generator or applying heat with a heater while the spangles, beads or the like are pressed against a target object, and hot-fixes of glass, metal, and artificial diamonds are melted and attached by applying an adhesive to back surfaces thereof and applying ultrasonic waves with an ultrasonic generator while the hot-fixes are pressed against the target object.

There are several methods of attaching decorations to fabric, including a method of directly attaching the decorations to the fabric, and a motif method in which the decorations are attached to a tape or the like and then the tape with the decorations attached is pressed and attached to the fabric.

However, in any case, the decorations have to be supplied accurately one by one to an attachment unit so that the attachment unit can attach the decorations one by one to correct locations to complete a desired design. However, a conventionally proposed decoration attachment device has problems in which the supply of decorations is not uniform, such as when decorations are accurately supplied one by one, but in other cases multiple decorations are supplied at once.

In order to solve this problem, a related art such as Korean Patent No. 10 -1553510 (Title of invention: Decoration supply unit for decoration attachment device) was proposed to accurately supply decorations one by one, thereby making it possible to easily implement a desired design. However, since the decoration supply unit according to this related art has a problem in that a rotating disk for exchanging decorations and a decoration supply rotating plate are located on both sides of a horizontal plane through different axes, the overall volume of the device is large and its structure is complex, making it difficult to manufacture.

### DISCLOSURE

### Technical Problem

The present invention has been devised to solve the problems of the above-described related art, and an object thereof is to provide a decoration feeder of a decoration attachment device that can accurately supply decorations, thereby easily implementing a desired design, and can have a simplified structure for exchanging decorations, thereby making an overall size of a product smaller and easier to manufacture.

### Technical Solution

A decoration feeder of a decoration attachment device according to the present invention for solving the above-described problem includes a storage container in which decorations are stored, a main body which supports the storage container and into which the decorations are introduced into a through hole formed in a center, a rotating plate in which insertion holes into which the decorations introduced into the through hole of the main body are inserted one by one are formed at regular intervals along an edge, a decoration support plate provided below the rotating plate to support the decorations inserted into the insertion hole from below, and having a flat support portion formed at an edge in a downwardly sagging shape, and a passage hole formed next to the flat support portion to drop the decorations downward, a rotating drum which rotates below the decoration support plate and transmits a rotational force to the rotating plate to rotate the rotating plate, and in which settling holes in which the decorations dropped through the passage hole are adsorbed by vacuum pressure are formed at regular intervals along an outer circumferential surface, a guide drum having an opening at a lower end and disposed concentrically and closely along an inner circumferential of the rotating drum to guide movement of the decorations, and a push pin which is detachably installed inside the guide drum and repeatedly moves up and down when the decorations settled in the settling holes pass over the opening to discharge the decorations one by one to an outside of the rotating drum.

Meanwhile, the decoration feeder of a decoration attachment device may further include a decoration pressure plate provided above the rotating plate, and the decoration pressure plate may include a main body disposed above the rotating plate, a pressing part which is integrally formed on an edge of the main body and presses the decorations inserted into the insertion hole of the rotating plate from above, an inclined line which is formed on an inlet side of the pressing part and collides with the approaching decorations in a state in which the decorations are inserted into the insertion hole, and a leaf spring which is formed on an outlet side of the pressurizing portion and presses an upper surface of the rotating plate.

Here, when the decorations are formed with flat bottom surfaces and round or inclined upper surfaces, and the decorations are inserted into the insertion hole with the bottom surfaces facing upward and collide with the inclined line, the upper surfaces of the decorations may pass over the inclined line and the decorations may be separated from the insertion hole

Additionally, in order to prevent the decorations settled in the settling holes of the rotating drum from being separated to the outside before reaching below the push pin, an upper guide and a lower guide may be installed on an outer surface of the rotating drum.

Here, the upper guide may have a curved portion of which a bottom surface surrounds the outer surface of the rotating drum, and a flat portion which is provided on an upper side of the curved portion and forms a gap between the flat portion and the curved portion, into which a portion of the edge of the rotating plate is sequentially and continuously inserted.

Additionally, a bracket may be installed and fixed to the main body, the lower guide is mounted on the bracket, and a spring is installed on the bracket and the lower guide to bring the lower guide into close contact with the bracket.

Meanwhile, a sub-body may be installed below the main body, a rotation transmission part which transmits a rotational force of the rotating drum to the rotating plate may be installed inside the sub-body, and the rotation transmission part may include a shaft provided with a first angled portion coupled to an angled hole formed in a center of the rotating plate and a second angled portion formed below the first angled portion which are spaced apart from each other vertically on an outer surface of a circular portion, a first gear penetrated by the circular portion between the first angled portion and the second angled portion and engaged with a gear tooth formed on the rotating drum to rotate together when the rotating drum rotates, a second gear provided on a bottom surface of the first gear to rotate together with the first gear, a reducer including a plurality of gears which receive a rotational force from the second gear to rotate, and a third gear which is penetrated in the same shape as the second angled portion and receives a rotational force from the reducer to rotate the shaft and thus rotates the rotating plate.

Here, the reducer may include a first reduction gear engaged with the second gear to rotate, a second reduction gear which is installed on the same shaft as the first reduction gear and rotates together with the first reduction gear, a third reduction gear engaged with the second reduction gear to rotate, and a fourth reduction gear engaged with the third reduction gear and engaged with the third gear to transmit a rotational force of the third reduction gear to the third gear.

### Advantageous Effects

The decoration feeder of the decoration attachment device of the present invention configured as described above has an advantage in that, since a rotating plate for exchanging decorations and a decoration support plate are disposed in an up-down direction rather than a left-right direction, and a rotating drum is disposed under the decoration support plate, it is possible for the device to accurately supply the decorations with a simplified structure and reduced size.

In addition, since a push pin is detachably installed inside a guide drum provided inside a rotating disc, there is an advantage in that the push pin, the guide drum, and the rotating disc can be easily cleaned.

### DESCRIPTION OF DRAWINGS

FIG. 1 is a view showing an appearance of a decoration attachment device using a decoration feeder according to the present invention.

FIG. 2 is a view showing a relationship between the decoration feeder and a driving unit according to the present invention.

FIG. 3 is a view showing a vacuum generation unit and a decoration attachment unit of the decoration attachment device according to the present invention.

FIG. 4 is a view showing the decoration feeder according to the present invention connected to a driving drum.

FIGS. 5 to 8 are exploded perspective views showing the decoration feeder according to the present invention.

FIGS. 9 and 10 are views showing a rotation transmission part of the decoration feeder according to the present invention.

FIGS. 11 to 15 are views showing a process of attaching a decoration using the decoration feeder according to the present invention.

### BEST MODE

A decoration feeder of a decoration attachment device of the present invention includes a storage container in which decorations are stored, a main body which supports the storage container and into which the decorations are introduced into a through hole formed in a center, a rotating plate in which insertion holes into which the decorations introduced into the through hole of the main body are inserted one by one are formed at regular intervals along an edge, a decoration support plate provided below the rotating plate to support the decorations inserted into the insertion hole from below, and having a flat support portion formed at an edge in a downwardly sagging shape, and a passage hole formed next to the flat support portion to drop the decorations downward, a rotating drum which rotates below the decoration support plate and transmits a rotational force to the rotating plate to rotate the rotating plate, and in which settling holes in which the decorations dropped through the passage hole are adsorbed by vacuum pressure are formed at regular intervals along an outer circumferential surface, a guide drum having an opening at a lower end and disposed concentrically and closely along an inner circumferential of the rotating drum to guide movement of the decorations, and a push pin which is detachably installed inside the guide drum and repeatedly moves up and down when the decorations settled in the settling holes pass over the opening to discharge the decorations one by one to an outside of the rotating drum.

### Modes of the Invention

Hereinafter, an embodiment of a decoration feeder of a decoration attachment device according to the present invention will be described in detail with reference to the attached drawings.

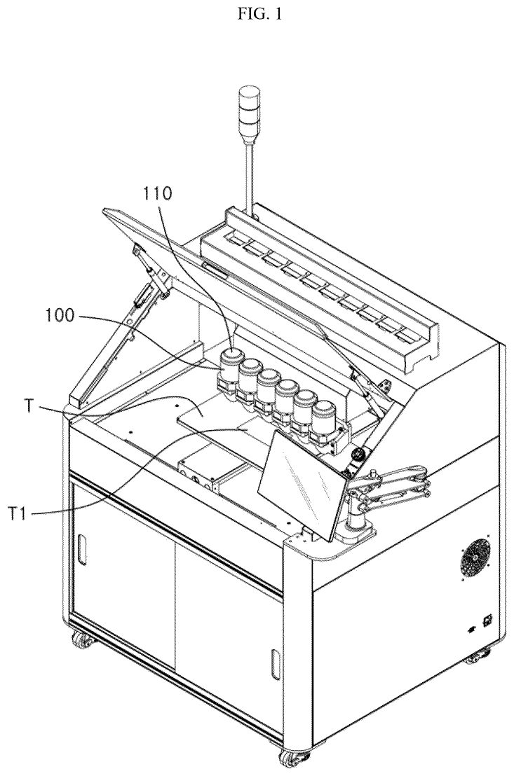

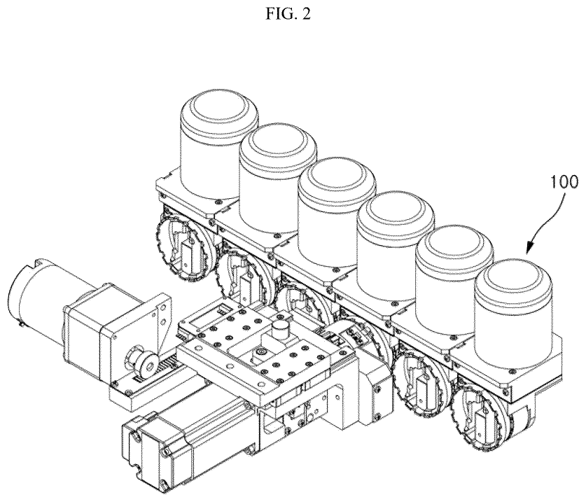

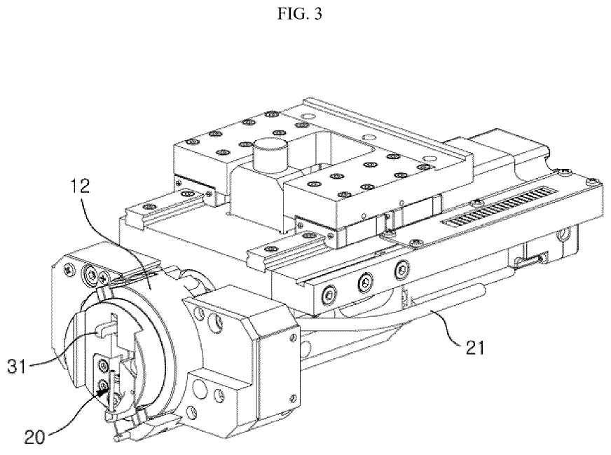

FIG. 1 is a view showing an appearance of the decoration attachment device using the decoration feeder according to the present invention, FIG. 2 is a view showing a relationship between the decoration feeder and a driving unit according to the present invention, and FIG. 3 is a view showing a vacuum generation unit and a decoration attachment unit of the decoration attachment device according to the present invention.

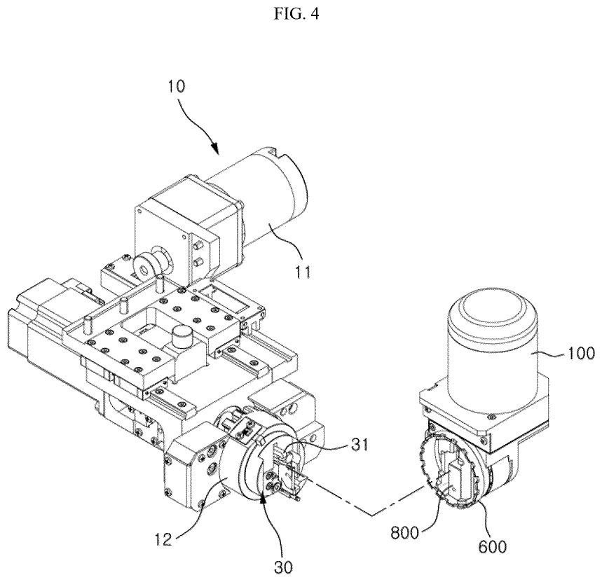

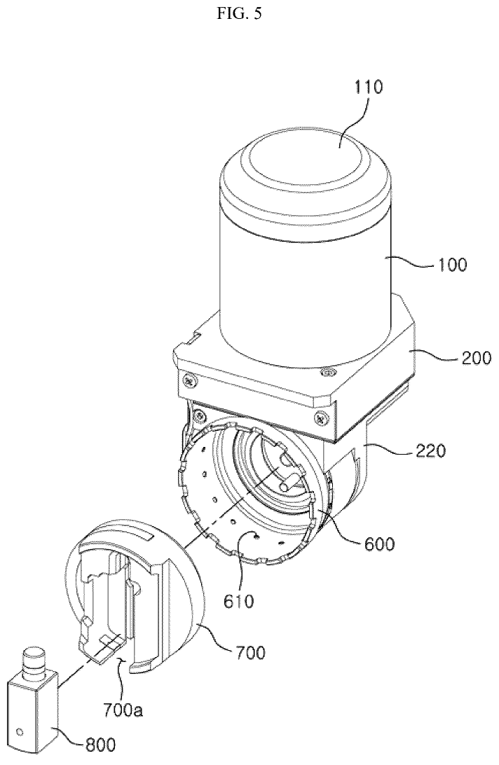

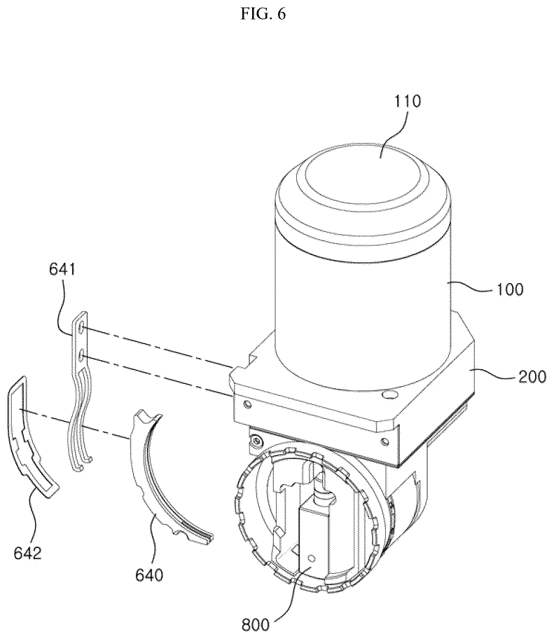

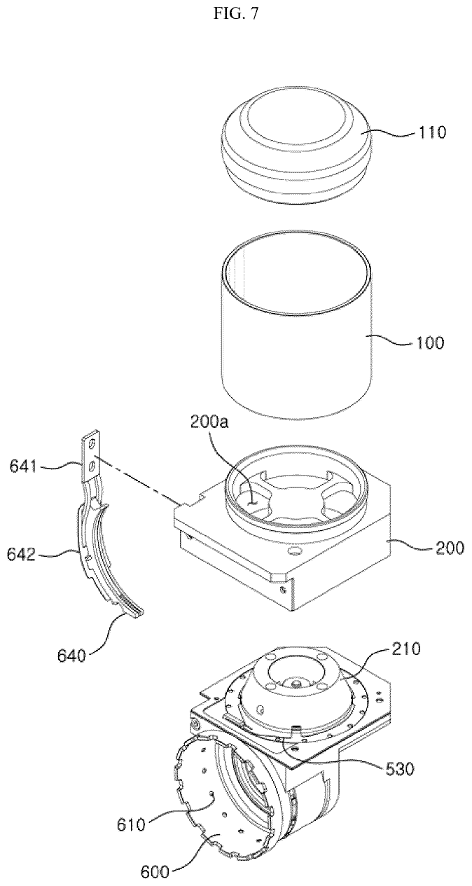

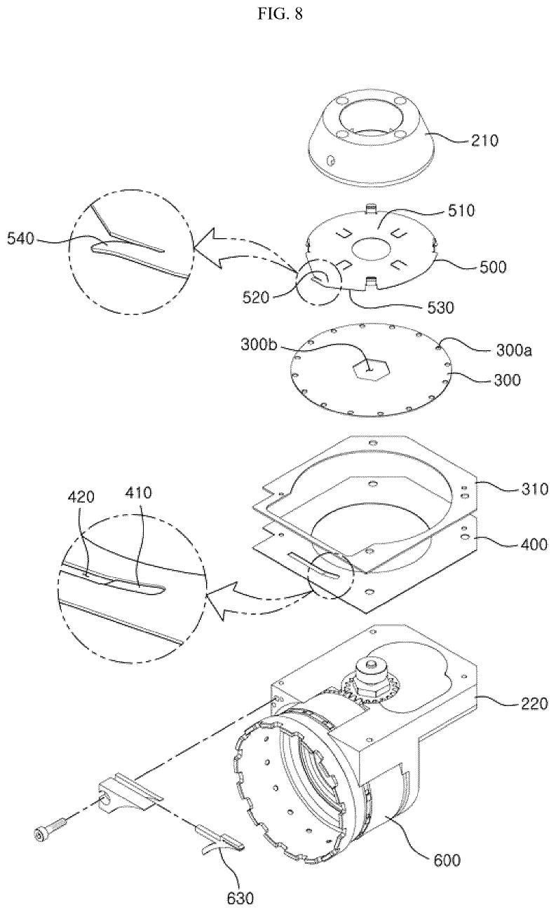

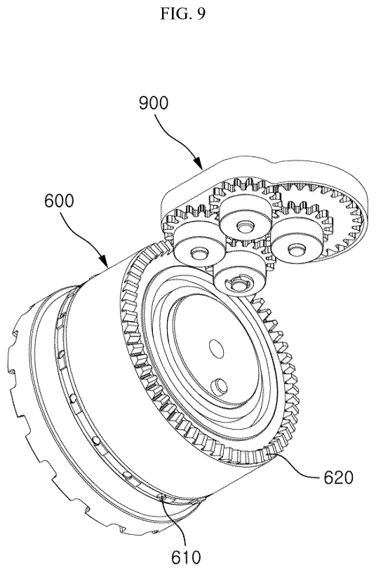

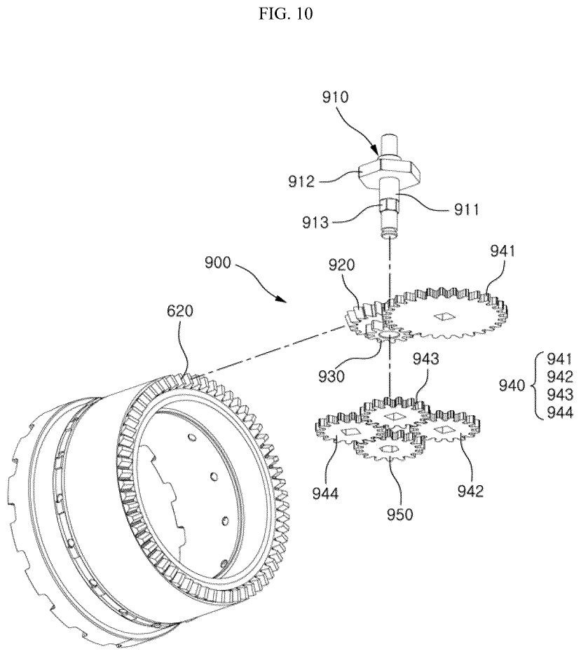

Additionally, FIG. 4 is a view showing the decoration feeder according to the present invention connected to a driving drum, FIGS. 5 to 8 are exploded perspective views showing the decoration feeder according to the present invention, and FIGS. 9 and 10 are views showing a rotation transmission part of the decoration feeder according to the present invention.

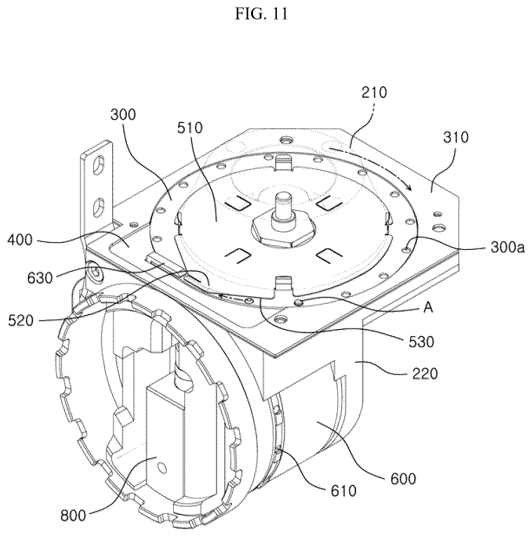

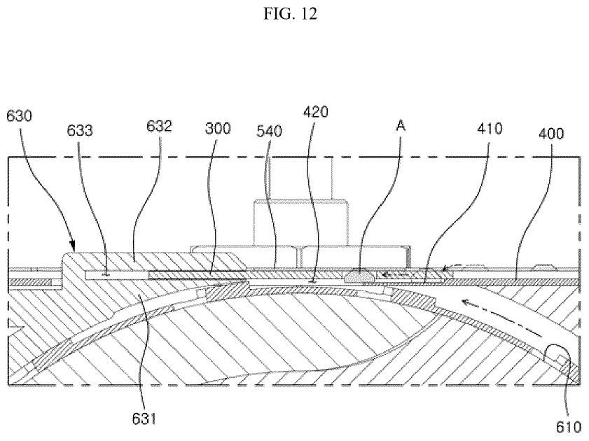

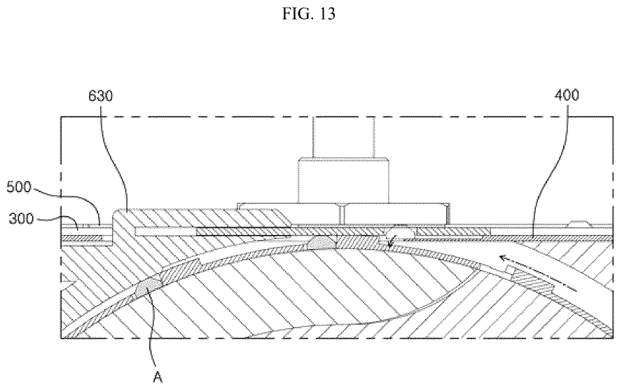

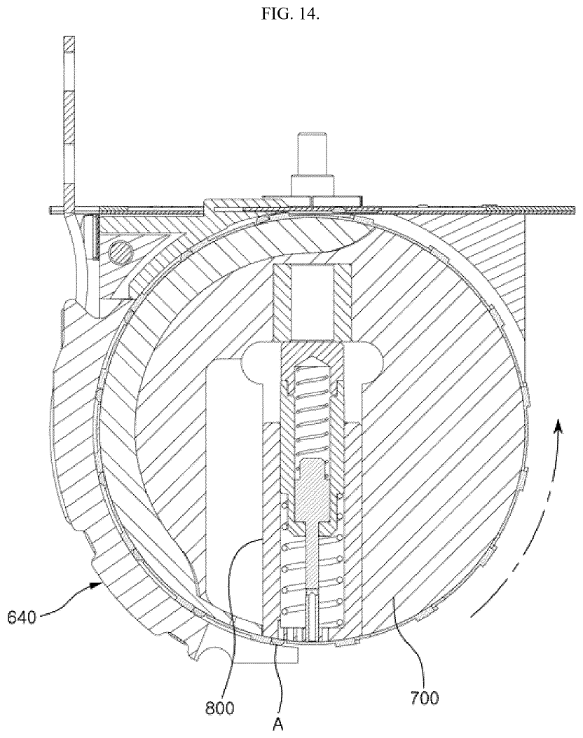

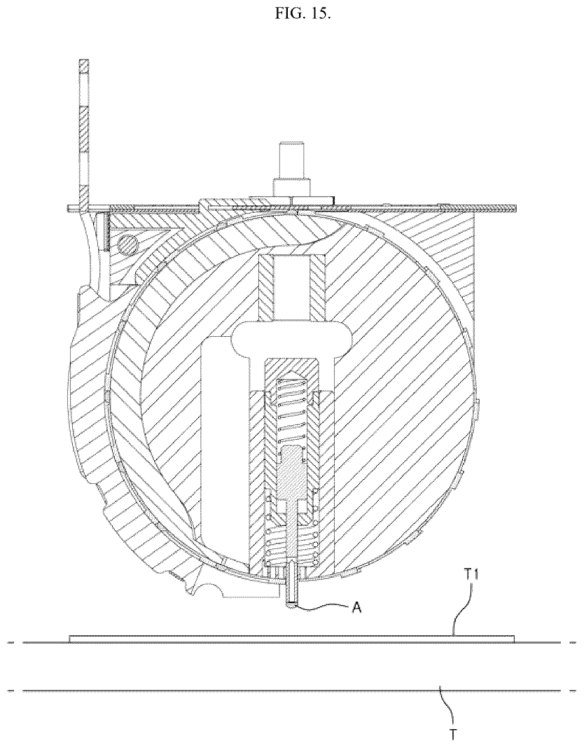

Further, FIGS. 11 to 15 are views showing a process of attaching a decoration using the decoration feeder according to the present invention.

The decoration feeder of the decoration attachment device according to the present invention is a component of the decoration attachment device including a driving unit 10 including a driving drum 12 which receives power from a driving motor 11 to be rotated, a vacuum generation unit 20 which provides repeatedly generated vacuum pressure through a vacuum pipe 21, a decoration attachment unit 30 including a nozzle arm 31 which repeatedly presses a push pin 800, which will be described below, to attach a decoration A to a tape T1 on a work table T, and various other components.

Thus, the decoration feeder of the decoration attachment device according to the present invention may not exhibit its function by itself, and is mounted in the decoration attachment device including various components as described above, thereby enabling the decorations A to be attached one by one to the tape T1 in a desired shape.

Because the above-described components constituting the decoration attachment device, that is, the driving unit 10, the vacuum generation unit 20, the decoration attachment unit 30 and various other components, are identical or similar to those in the conventional technology (Korean Patent No. 10-1470937), a detailed description of the conventional technology will be omitted here, and the description will be developed focusing on the decoration feeder of the present invention.

A decoration supply unit of the decoration attachment device according to the present invention includes a storage container 100, a main body 200 which supports the storage container 100 and has a through hole 200a formed therein, a rotating plate 300 installed inside the through hole 200a of the main body 200, a decoration support plate 400 provided below the rotating plate 300, a decoration pressure plate 500 provided above the rotating plate 300, a rotating drum 600 which is connected to the driving drum 12 of the driving unit 10 to be rotated, a guide drum 700 installed inside the rotating drum 600, a push pin 800 detachably installed inside the guide drum 700, and a rotation transmission part 900 which transmits a rotational force of the rotating drum 600 to the rotating plate 300.

The storage container 100 is formed as a cylindrical container with a cover 110 and an open bottom, and stores a large amount of decorations A therein. When the storage container 100 is installed on an upper surface of the main body 200, the storage container 100 communicates directly with the through hole 200a formed in the main body 200, and thus the large amount of decorations A are supplied to the through hole 200a.

The main body 200 is installed below the storage container 100 to support the storage container 100. The main body 200 has the through hole 200a formed in the center. The decorations A inside the storage container 100 described above are introduced into the through hole 200a of the main body 200.

The rotating plate 300 has insertion holes 300a formed at regular intervals along an edge, into which the decorations A introduced into the through hole 200a of the main body are inserted one by one. The rotating plate 300 receives a rotational force of the driving motor 11 through the rotating drum 600 and the rotation transmission part 900 and thus rotates within the through hole 200a.

Meanwhile, a diffusion block 210 of which a diameter increases as it goes downward is installed inside the main body 200 to guide the large amount of decorations A supplied from above toward the insertion holes 300a formed at the edge of the rotating plate 300.

Additionally, a frame plate 310 having the same height as the rotating plate 300 is installed around a circumference of the rotating plate 300. Therefore, the rotating plate 300 rotates inside the frame plate 310.

The decoration support plate 400 has a central opening and an edge portion that is in close contact with a bottom edge of the rotating plate 300 to support the decorations A inserted one by one into each of the insertion holes 300a of the rotating plate 300 from below. A flat support portion 410 having a downwardly sagging shape is formed at the edge of the decoration support plate 400, and a passage hole 420 is formed next to the flat support portion 410.

The flat support portion 410 is formed integrally with the decoration support plate 400, and is formed in a downwardly recessed shape so that its height is lower than that of other portions of the decoration support plate 400.

The decorations A inserted into the insertion holes 300a of the rotating plate 300 rotate in a state in which they are surrounded by the insertion holes 300a, and when the flat support portion 410 is located directly therebelow, the decorations A fall downward so that flat bottom surfaces thereof come into contact with an upper surface of the flat support portion 410.

In this case, the decoration A which falls to the lower side of the insertion hole 300a does not completely fall below the insertion hole 300a, an upper portion thereof still remains surrounded by the insertion hole 300a, only a lower portion thereof falls below the insertion hole 300a, and the bottom surface comes into contact with the upper surface of the flat support portion 410. Thus, even when the bottom surface of the decoration A is in contact with the upper surface of the flat support portion 410, the decoration A is guided by an inner wall surface of the rotating plate 300, which forms the insertion hole 300a, to be moved.

The passage hole 420 is formed right next to an end portion of the flat support portion 410.

Since the decoration A settled on the upper surface of the flat support portion 410 maintains a state in which the upper portion thereof is surrounded within the insertion hole 300a of the rotating plate 300, the decoration A is guided by the rotating plate 300 that keeps rotating to move toward the passage hole 420, and when the passage hole 420 is located therebelow, the decoration A falls downward through the passage hole 420.

The decoration pressure plate 500 is installed above the rotating plate 300, but since a diameter thereof is formed smaller than a diameter of the rotating plate 300, most of the insertion holes 300a located at the edge of the rotating plate 300 are exposed outside the circumference of the decoration pressure plate 500. However, some of the insertion holes 300a of the rotating plate 300 are not exposed to the outside because they are located below the decoration pressure plate 500.

To explain in more detail, the decoration pressure plate 500 includes a main body 510, a pressing part 520 integrally formed on an edge of the main body 510, an inclined line 530 formed on the inlet side of the pressing part 520, and a leaf spring 540 formed on the outlet side of the pressing part 520.

The main body 510 is disposed on the upper side of the rotating plate 300 and is formed to have a diameter smaller than the diameter of the rotating plate 300.

The pressing part 520 is formed to extend integrally outward from one side of the edge of the main body 510, and presses the decoration A from above when the decoration A inserted into the insertion hole 300a of the rotating plate 300 comes in from below.

The inclined line 530 collides with the approaching decoration A in a state in which the decoration A is inserted into the insertion hole 300a of the rotating plate 300.

The leaf spring 540 presses the upper surface of the rotating plate 300. That is, the spring 642 is manufactured in a slightly downwardly curved shape to provide an elastic force downward from the time of manufacture, the leaf spring 540 presses the upper surface of the rotating plate 300 when the rotating plate 300 rotates underneath, and an end portion thereof is inserted into the insertion hole 300a when the insertion hole 300a is located therebelow.

Typically, the decoration A has a flat bottom surface and a rounded or slanted upper surface, which makes it shine and enhances aesthetic feeling. Therefore, the bottom surface should be adhered to a surface of clothing or a bag with an adhesive, while the shiny, rounded upper surface should be exposed to the outside. However, when some decorations A have their upper surfaces exposed to the outside and other decorations A have their lower surfaces exposed to the outside, decorative beauty is reduced, and thus the decorations A have to be delivered to the decoration supply rotating plate 300 in the same state.

To achieve this purpose, in the present invention, the decoration pressure plate 500 is maintained in a fixed state without rotating, and the rotating plate 300 made of steel thinner than a thickness of the decoration A rotates at high speed below the decoration pressure plate 500 so that the decoration A inserted into the insertion hole 300a of the rotating plate 300 collides with the inclined line 530.

When the decoration A colliding with the inclined line 530 is inserted into the insertion hole 300a with its bottom surface facing downward, the inclined line 530 passes by while brushing against the upper surface of the decoration A, so that the decoration A with its bottom surface facing downward enters under the pressing part 520.

However, when the decoration A colliding with the inclined line 530 is inserted into the insertion hole 300a with its bottom surface facing upward, the inclined line 530 collides with the upper surface of the decoration A, the upper surface of the decoration A passes over the inclined line 530, and eventually the decoration A is separated from the insertion hole 300a. In this way, the decoration which has been separated from the insertion hole 300a by the inclined line 530 bounces to the upper surface of the pressure plate 500.

Based on this principle, in the present invention, only the decoration A with the flat bottom surface facing downward and the round or inclined upper surface facing upward is supplied to a settling hole 610 of the rotating drum 600.

The rotating drum 600 rotates below the decoration support plate 400 and transmits a rotational force to the rotating plate 300 to rotate the rotating plate 300, and the settling hole 610 through which the decoration A that has fallen downward through the passage hole 420 of the decoration support plate 400 is absorbed and settled by vacuum pressure is formed at regular intervals along an outer circumferential surface thereof.

In detail, the rotating drum 600 is connected to the driving drum 12 of the driving unit 10 and receives a rotational force from the driving drum 12. Therefore, the rotating drum 600 rotates together with the driving drum 12. The rotating drum 600 has a number of settling holes 610 formed at regular intervals along the outer circumferential surface, and gear teeth 620 formed on a front edge portion.

The decoration A is settled in the settling hole 610. When a space between the rotating drum 600 and the driving drum 12 is formed into a vacuum by vacuum pressure provided through the vacuum pipe 21, the decoration A is absorbed by the vacuum pressure and thus firmly settled in the settling hole 610.

The gear teeth 620 formed on the rotating drum 600 are engaged with a first gear 920 of the rotation transmission part 900 to provide a rotational force that enables the rotating plate 300 to rotate. A connection relationship between the rotation transmission part 900, the rotating drum 600, and the rotating plate 300 will be described below.

The guide drum 700 has an opening 700a at a lower end and is disposed concentrically and closely along an inner circumferential surface of the rotating drum 600 to guide movement of the decoration A.

To explain in more detail, the rotating drum 600 rotates while supported by a bearing interposed between the rotating drum 600 and the guide drum 700. The guide drum 700 that supports the rotating drum 600 in this way is a cylindrical drum with the opening 700a formed at the lower end, an open rear, and a closed front, and is also used as a means for guiding the decoration A so that the decoration A can move stably without falling out of the settling hole 610 of the rotating drum 600.

Therefore, the decoration A in the settling hole 610 of the rotating drum 600 is guided by the outer circumferential surface of the guide drum 700 that surrounds an inner circumference of the rotating drum 600, so that separation of the decoration A is prevented and the decoration A moves downward and then can escape in a section in which the opening 700a is located.

The push pin 800 is detachably installed inside the guide drum 700 in a one-touch manner. When the decoration A settled in the settling hole 610 of the rotating drum 600 passes through the opening 700a of the guide drum 700, the push pin 800 repeatedly moves up and down, pushes the decoration A out of the settling hole 610 one by one, and discharges the decoration A to the outside of the rotating drum 600.

In detail, the push pin 800 repeatedly receives a pressing force from the nozzle arm 31 of the decoration attachment unit 30 to be repeatedly pushed up and down, thereby discharging the decoration A. When the push pin 800 is moved down in this way to discharge the decoration A, the vacuum pressure provided through the vacuum pipe 21 is momentarily not provided within the rotating drum 600, and when the vacuum pressure is not provided in this way, the absorption force is lost, and thus there is a possibility that the decoration A will be separated from the settling hole 610. Therefore, when an upper guide 630 and a lower guide 640 surround a portion of the rotating drum 600, in which the settling hole 610 is formed, from the outside, the decoration A can be prevented from being separated from the settling hole 610.

That is, the upper guide 630 and the lower guide 640 are installed on an outer surface of the rotating drum 600 to prevent the decoration A settled in the settling hole 610 of the rotating drum 600 from being separated to the outside before reaching the lower side of the push pin 800, and surround a length which is approximately slightly less than half of the outer surface of the rotating drum 600 from an upper portion of the rotating drum 600 to the push pin 800.

The upper guide 630 surrounds a portion of the upper side of the rotating drum 600, and has a curved portion 631 and a flat portion 632 provided on the upper side of the curved portion 631.

The curved portion 631 has a bottom surface with the same curvature as a curved surface of the rotating drum 600 and surrounds the outer surface of the rotating drum 600.

The flat portion 632 forms a gap 633 between the flat portion 632 and the curved portion 631, into which a portion of the edge of the rotating plate 300 that keeps rotating is sequentially and continuously inserted. That is, a certain gap 633 is formed between the flat portion 632 and the curved portion 631, and a portion of the edge of the rotating plate 300 that continues to rotate is sequentially inserted into the gap 633.

Meanwhile, since the curved portion 631 surrounds the outer surface of the rotating drum 600, the decoration A settled in the settling hole 610 of the rotating drum 600 passes over a bottom surface of the curved portion 631 while moving, and is thus positioned more stably within the settling hole 610.

The lower guide 640 is installed directly below the upper guide 630, surrounds the outer surface of the rotating drum 600, and is installed on the outer surface of the rotating drum 600 to be easily detached and attached.

That is, a bracket 641 is installed on the main body 200, and an upper end of the bracket 641 is bolted and fixed to a side surface of the main body 200. The lower guide 640 is mounted on the bracket 641, and a spring 642 that brings the lower guide 640 into close contact with the bracket 641 is installed on the bracket 641 and the lower guide 640. That is, the bracket 641 and the lower guide 640 are in close contact with each other due to an elastic force of the spring 642. Therefore, since the lower guide 640 may be detached from the bracket 641 simply by removing the spring 642, there is an advantage of making cleaning and repair easy.

The rotation transmission part 900 transmits the rotational force of the rotating drum 600 to rotate the rotating plate 300. In detail, a sub-body 220 is installed below the main body 200, and a rotation transmission part 900 is installed within the sub-body 220. In addition, the rotating drum 600 is rotatably installed in the sub-body 220 in an up-down direction.

The rotation transmission part 900 installed within the sub-body 220 includes a shaft 910, a first gear 920, a second gear 930, a reducer 940, and a third gear 950 which are installed on the shaft 910.

The shaft 910 is provided with a first angled portion 912 coupled to an angled hole 300b formed in the center of the rotating plate 300 and a second angled portion 913 formed below the first angled portion 912 which are spaced apart from each other vertically on an outer surface of a circular portion 911.

That is, the shaft 910 has the circular portion 911 having a long circular rod shape as a basic configuration, and in the middle thereof, the first angled portion 912 and the second angled portion 913 having an angled shape of a certain height rather than a circular rod shape are provided. In this case, the first angled portion 912 is provided above the second angled portion 913.

The first angled portion 912 passes through the center of the rotating plate 300 and provides a rotational force to the rotating plate 300. That is, when the first angled portion 912 has a hexagonal shape, the angled hole 300b formed in the center of the rotating plate 300 also has a hexagonal shape, and thus when the shaft 910 rotates, the rotating plate 300 also rotates in the same manner.

The first gear 920 is penetrated by the circular portion 911, and is penetrated by the circular portion between the first angled portion 912 and the second angled portion 913. The first gear 920 is in the form of a bevel gear and is engaged with the gear teeth 620 formed on a front surface of the rotating drum 600 to rotate together with the rotation of the rotating drum 600 and converts vertical rotation of the rotating drum 600 into horizontal rotation.

The second gear 930 is provided on a bottom surface of the first gear 920 and rotates together with the first gear 920. That is, the second gear 930, like the first gear 920, is penetrated by the circular portion between the first angled portion 912 and the second angled portion 913 and is in close contact with the bottom surface of the first gear 920 to rotate in the same manner as the first gear 920.

The reducer 940 includes a plurality of gears that receive a rotational force from the second gear 930 to rotate.

More specifically, the reducer 940 includes a first reduction gear 941, a second reduction gear 942, a third reduction gear 943, and a fourth reduction gear 944.

The first reduction gear 941 rotates while engaged with the second gear 930, the second reduction gear 942 is installed on the same shaft as the first reduction gear 941 and rotates together with the first reduction gear 941, and the third reduction gear 943 rotates while engaged with the second reduction gear 942.

Additionally, the fourth reduction gear 944 is engaged with the third reduction gear 943 and engaged with the third gear 950 to transmit a rotational force of the third reduction gear 943 to the third gear 950.

The third gear 950 is penetrated in the same form as the second angled portion 913 of the shaft 910, and receives a rotational force from the reducer 940 to rotate the shaft 910, thereby rotating the rotating plate 300.

In detail, when the rotating drum 600 rotates, the first gear 920 and the second gear 930 rotate. In this case, the shaft 910 does not rotate.

When the second gear 930 rotates, the first reduction gear 941 and the second reduction gear 942 rotate, and subsequently, the third reduction gear 943 and the fourth reduction gear 944 rotate.

When the fourth reduction gear 944 rotates, the third gear 950 rotates, and in this case, the shaft 910 rotates together with the third gear 950. Thus, the rotating plate 300 installed on the first angled portion 912 of the shaft 910 also rotates.

### INDUSTRIAL APPLICABILITY

The present invention relates to a decoration feeder of a decoration attachment device, and is intended to supply decorations to be attached to products such as clothing, bags, and belts, and thus can be widely used in the textile and fashion industries.

1. A decoration feeder of a decoration attachment device, comprising:
a storage container (100) in which decorations (A) are stored;
a main body (200) which supports the storage container (100) and into which the decorations (A) are introduced into a through hole (200a) formed in a center;
a rotating plate (300) in which insertion holes (300a) into which the decorations (A) introduced into the through hole (200a) of the main body (200) are inserted one by one are formed at regular intervals along an edge;
a decoration support plate (400) provided below the rotating plate (300) to support the decorations (A) inserted into the insertion hole (300a) from below, and having a flat support portion (410) formed at an edge in a downwardly sagging shape, and a passage hole (420) formed next to the flat support portion (410) to drop the decorations (A) downward;
a rotating drum (600) which rotates below the decoration support plate (400) and transmits a rotational force to the rotating plate (300) to rotate the rotating plate (300), and in which settling holes (610) in which the decorations (A) dropped through the passage hole (420) are adsorbed by vacuum pressure are formed at regular intervals along an outer circumferential surface;
a guide drum (700) having an opening (700a) at a lower end and disposed concentrically and closely along an inner circumferential of the rotating drum (600) to guide movement of the decorations (A); and
a push pin (800) which is detachably installed inside the guide drum (700) and repeatedly moves up and down when the decorations (A) settled in the settling holes (610) pass over the opening (700a) to discharge the decorations (A) one by one to an outside of the rotating drum (600).

2. The decoration feeder of a decoration attachment device of claim 1, further comprising a decoration pressure plate (500) provided above the rotating plate (300),
wherein the decoration pressure plate (500) includes:
a main body (510) disposed above the rotating plate (300);
a pressing part (520) which is integrally formed on an edge of the main body (510) and presses the decorations (A) inserted into the insertion hole (300a) of the rotating plate (300) from above;
an inclined line (530) which is formed on an inlet side of the pressing part (520) and collides with the approaching decorations (A) in a state in which the decorations (A) are inserted into the insertion hole (300a); and
a leaf spring (540) which is formed on an outlet side of the pressurizing portion (520) and presses an upper surface of the rotating plate (300).

3. The decoration feeder of a decoration attachment device of claim 2, wherein, when the decorations (A) are formed with flat bottom surfaces and round or inclined upper surfaces, and the decorations (A) are inserted into the insertion hole (300a) with the bottom surfaces facing upward and collide with the inclined line (530), the upper surfaces of the decorations (A) pass over the inclined line (530) and the decorations (A) are separated from the insertion hole (300a).

4. The decoration feeder of a decoration attachment device of claim 1, wherein, in order to prevent the decorations (A) settled in the settling holes (610) of the rotating drum (600) from being separated to the outside before reaching below the push pin (800), an upper guide (630) and a lower guide (640) are installed on an outer surface of the rotating drum (600).

5. The decoration feeder of a decoration attachment device of claim 4, wherein the upper guide (630) has:
a curved portion (631) of which a bottom surface surrounds the outer surface of the rotating drum (600); and
a flat portion (632) which is provided on an upper side of the curved portion (631) and forms a gap (633) between the flat portion (632) and the curved portion (631), into which a portion of the edge of the rotating plate (300) is sequentially and continuously inserted.

6. The decoration feeder of a decoration attachment device of claim 4, wherein a bracket (641) is installed and fixed to the main body (200), the lower guide (640) is mounted on the bracket (641), and a spring (642) is installed on the bracket (641) and the lower guide (640) to bring the lower guide (640) into close contact with the bracket (641).

7. The decoration feeder of a decoration attachment device of claim 1, wherein a sub-body (220) is installed below the main body (200), and a rotation transmission part (900) which transmits a rotational force of the rotating drum (600) to the rotating plate (300) is installed inside the sub-body (220), and
the rotation transmission part (900) includes:
a shaft (910) provided with a first angled portion (912) coupled to an angled hole (300b) formed in a center of the rotating plate (300) and a second angled portion (913) formed below the first angled portion (912) which are spaced apart from each other vertically on an outer surface of a circular portion (911);
a first gear (920) penetrated by the circular portion (911) between the first angled portion (912) and the second angled portion (913) and engaged with a gear tooth (620) formed on the rotating drum (600) to rotate together when the rotating drum (600) rotates;
a second gear (930) provided on a bottom surface of the first gear (920) to rotate together with the first gear (920);
a reducer (940) including a plurality of gears which receive a rotational force from the second gear (930) to rotate; and
a third gear (950) which is penetrated in the same shape as the second angled portion

(913) and receives a rotational force from the reducer (940) to rotate the shaft (910) and thus rotates the rotating plate (300).

8. The decoration feeder of a decoration attachment device of claim 7, wherein the reducer (940) includes:
a first reduction gear (941) engaged with the second gear (930) to rotate;
a second reduction gear (942) which is installed on the same shaft as the first reduction gear (941) and rotates together with the first reduction gear (941);
a third reduction gear (943) engaged with the second reduction gear (942) to rotate; and
a fourth reduction gear (944) engaged with the third reduction gear (943) and engaged with the third gear (950) to transmit a rotational force of the third reduction gear (943) to the third gear (950).
